(19) United States
(12) Patent Application Publication
(10) Pub. No.: US 2016/0367046 A1
(43) Pub. Date: Dec. 22, 2016

(54) INSULATED GLASS ENCLOSURE FOR REFRIGERATED DISPLAY CASE

(71) Applicant: Structural Concepts Corporation, Muskegon, MI (US)

(72) Inventors: Viktor John Anderson, Muskegon, MI (US); Raymond Alexander Peterson, Grand Haven, MI (US)

(21) Appl. No.: 15/254,056

(22) Filed: Sep. 1, 2016

Related U.S. Application Data
(62) Division of application No. 14/627,039, filed on Feb. 20, 2015.

(51) Int. Cl. A47F 3/04; F16B 47/00; A47F 3/00

(52) U.S. Cl. CPC A47F 3/0434; A47F 3/005; F16B 47/003; A47F 3/0469

(57) ABSTRACT

An insulated glass enclosure for a refrigerated display case includes a glass top panel, a glass front panel, and two glass side panels. The front panel and the side panels each include spaced inner and outer glass panes. The upper edges of the front panel and the side panels are bonded to the top panel; and the front edges of the side panels are bonded to the front panel. A spacer is bonded between the free edges of the inner and outer glass panes of the front panel and the side panels to complete the insulated glass panels.

### BACKGROUND OF THE INVENTION

The present invention relates to insulated glass, and more particularly to an insulated glass enclosure for a refrigerated display case.

Refrigerated display cases are well known and widely used for the retail display of products such as food and flowers. One goal of any display case is to maximize the product viewing area within the practicalities of the price point for the display case and manufacturing costs.

Typically, these practicalities are balanced by providing a metal frame and conventional insulated glass (IG) panels supported within the frame. Unfortunately, this approach reduces the viewable area, both because of the frame and the edges of the insulated glass. The IG panels include spacers between the glass panes about the outer periphery of the insulated glass. The display case frame that supports the IG panels overlaps and thereby hides the spacers, providing a decorative finished appearance to the display case. However, the frame provides a box-like appearance, which is undesirable for some customers; and the frame at least partially blocks viewing of the display case contents.

### SUMMARY OF THE INVENTION

The noted problems are addressed by the present invention providing an insulated glass display case that is substantially frameless, thereby significantly increasing the visibility of the display case contents.

In one embodiment, the display case includes a glass enclosure having a glass top, opposed side panels, and a front panel. One or more of the panels is an insulated glass panel having spaced inner and outer glass panes. The edges of the panes of the one panel are glued to an adjacent panel, thereby eliminating the need for an IG spacer along those edges. For example, the upper edges of the side panels and the front panel may be glued to the glass top; and the front edges of the side panels may be glued to the front panel. In this embodiment, the display case does not include IG spacers at the IG panel edged that abut another panel. The free edges of the IG panels (e.g. the edges that do not abut another panel) may include a conventional spacer.

In another embodiment, a display case includes an inner glass enclosure and an outer glass enclosure. The inner enclosure has opposed side panels, a front panel, and a top panel with edges glued to the abutting panels. The outer enclosure also has opposed side panels, a front panel, and a top panel again with edges glued to the abutting panels. The inner enclosure fits within the outer enclosure with a gap between the inner and outer enclosures. The free edges of the two enclosures are sealed together, for example with conventional spacers.

In related embodiment, a method of manufacturing an insulated glass display case includes forming an inner enclosure having front, top, and side panels in which each abutting edge is glued to its abutting panel; forming an outer enclosure having front, top, and side panels in which each abutting edge is glued to its abutting panel; placing the inner enclosure inside the outer enclosure with a gap between the enclosures; and sealing the inner and outer enclosures together, for example, suing conventional spacers. For example, the lower and rear edges may be so sealed.

In all embodiments, the display cases eliminate (or at least reduce) the use of IG spacers in the upper and front areas of the cases. Glass enclosures in accordance with the present invention therefore have increased visibility, while maintaining the ability to be used in refrigerated applications.

These and other features and advantages of the invention will be more fully understood and appreciated by reference to the entire application including the specification, the claims, and the drawings.

### BRIEF DESCRIPTION OF THE DRAWINGS

FIG. 1 is a front perspective view of a refrigerated display case having an insulated glass enclosure according to a first embodiment of the invention;

FIG. 2 is a rear perspective view of the insulated glass enclosure;

FIG. 3 is a cross-sectional view of the insulated glass enclosure taken along line III-III of FIG. 2;

FIG. 4 is a cross-sectional view of the insulated glass enclosure taken along line IV-IV of FIG. 2;

FIG. 5 is detail view of the encircled area V in FIG. 3;

FIG. 6 is detail view of the encircled area VI in FIG. 3;

FIG. 7 is detail view of the encircled area VII in FIG. 2;

FIG. 8 is detail view of the encircled area VIII in FIG. 4;

FIG. 9 is a rear perspective view of an insulated glass enclosure according to second embodiment of the invention;

FIG. 10 is a rear perspective exploded view of the inner enclosure and the outer enclosure of the insulated glass enclosure of the second embodiment;

FIG. 11 is a cross-sectional view of the insulated glass enclosure taken along line XI-XI of FIG. 9;

FIG. 12 is a cross-sectional view of the insulated glass enclosure taken along line XII-XII of FIG. 9;

FIG. 13 is detail view of the encircled area XIII in FIG. 11;

FIG. 14 is detail view of the encircled area XIV in FIG. 11;

FIG. 15 is detail view of the encircled area XV in FIG. 9;

FIG. 16 is detail view of the encircled area XVI in FIG. 12; and

FIG. 17 is a flowchart for a method of manufacturing the glass enclosure of the second embodiment.

### DESCRIPTION OF THE CURRENT EMBODIMENTS

### I. First Embodiment

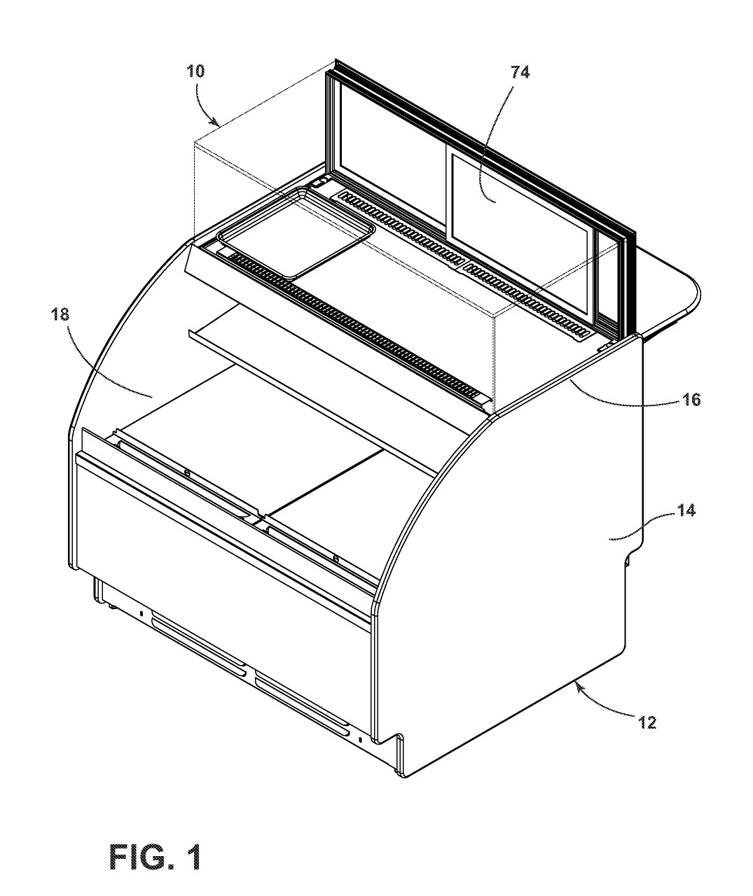

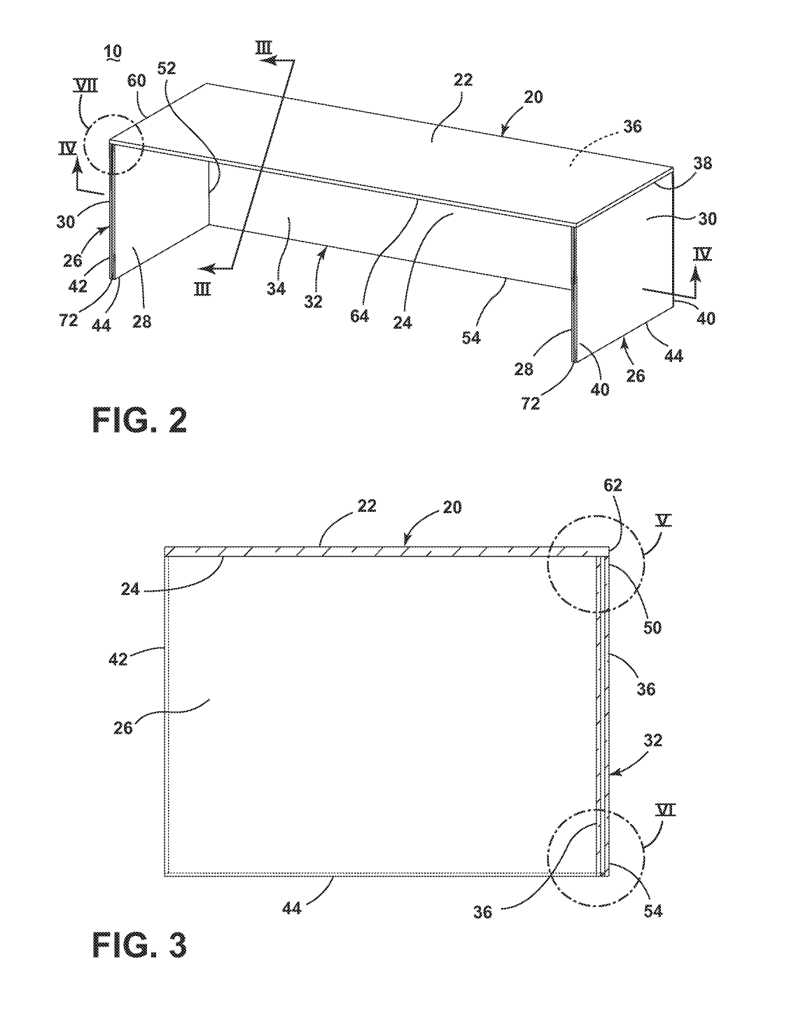

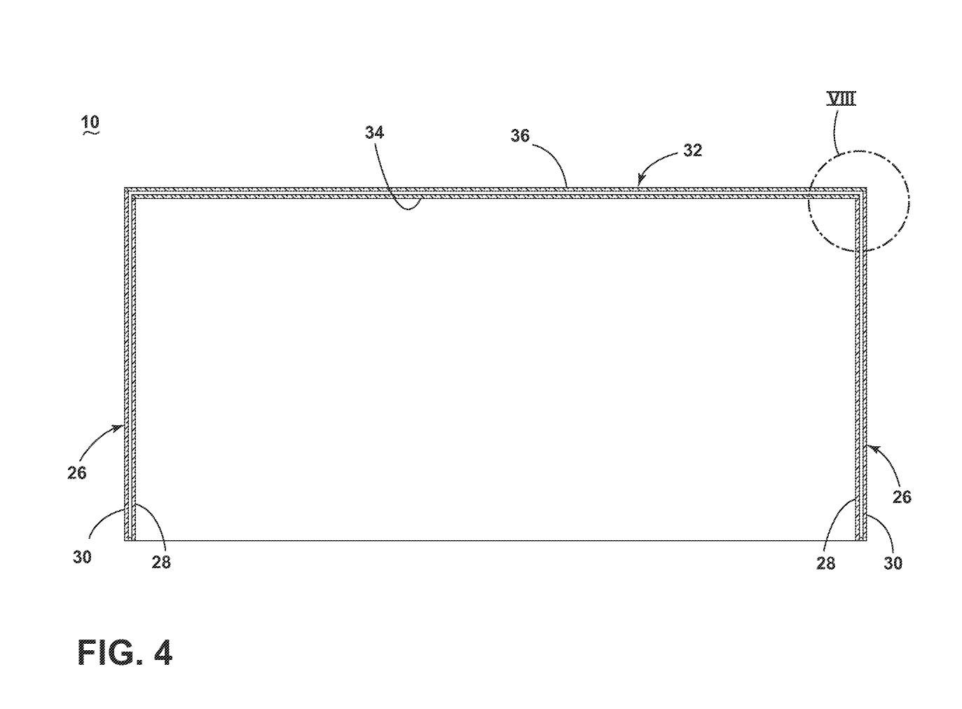

An insulated glass enclosure 10 for use with a refrigerated display case 12 in accordance with one or a first embodiment is illustrated in FIGS. 1-8. The glass enclosure 10 is particularly adapted for use in a display case of the type used in supermarkets, coffee shops, and other retail stores to display refrigerated merchandise. The glass enclosure is formed of insulated glass (IG) and is therefore useful in refrigerated applications, while at the same time providing a customer an essentially unobstructed view of the merchandise within.

Throughout this description, directional terms, such as “upper”, “lower”, “inner”, “outer”, “front”, and “rear”, are used to assist in describing the invention based on the orientation of the embodiment shown in the illustrations. More specifically, the below description refers to the display case 12 and glass enclosure 10 in the orientation shown in FIG. 1. The “front” side of the display case 12 is considered to be the side from which the customer would view the display case 12. Regardless, the use of directional terms should not be interpreted to limit the invention to any specific orientation(s).

The display case 12 includes a cabinet 14 of conventional construction that houses the mechanical equipment that provides cooling, such as an evaporator assembly, fan, etc. In the example shown in FIG. 1, the display case 12 includes an upper display area 16, including the insulated glass enclosure 10, and a lower display area 18, which may or may not be refrigerated.

The glass enclosure 10 includes a substantially horizontal glass top 20 having an upper surface 22 and a lower surface 24. The glass enclosure 10 also includes two generally vertical, opposed side panels 26 each including spaced inner and outer glass panes 28 and 30. Further, the glass enclosure includes a generally vertical front panel 32 including spaced inner and outer glass panes 34 and 36. These panels are arranged to form a structure having four surfaces where the adjacent sides are oriented at 90° angles, forming corners therebetween. The number, the shapes, and the orientations of the panels may vary depending on the desired shape of the enclosure.

Each of the side panels 26 defines four edges: an upper edge 38, a front edge 40, a rear edge 42, and a lower edge 44. The front panel 32 also defines four edges: an upper edge 50, two opposed side edges 52, and a lower edge 54. Lastly, the glass top 20 has four edges: two opposed side edges 60, a front edge 62, and a rear edge 64.

Referring to the detail view illustrated in FIG. 7, the upper edge 38 of the side panel 26 is bonded to the lower surface 24 of the glass top 20, forming a corner therebetween. More specifically, the upper edges 38 of the inner and outer glass panes 28 and 30 of the side panel 26 are bonded to the lower surface 24 of the glass top 20, along the glass top's 20 side edge 60. The opposed side panel is arranged in mirror image relationship to the described side panel 26 and does not require further description.

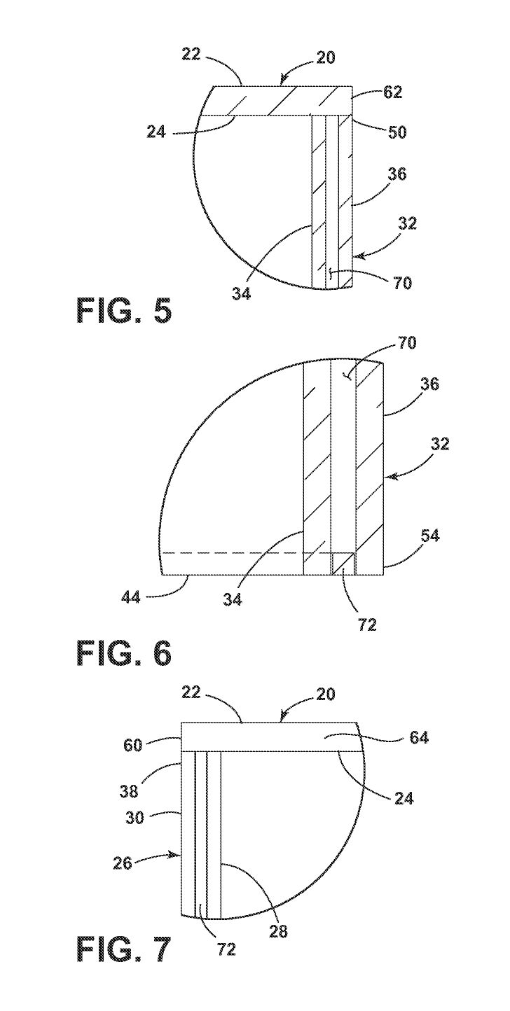

Referring to the detail view illustrated in FIG. 5, the upper edge 50 of the front panel 32 is bonded to the lower surface 24 of the glass top 20 along the glass top's 20 front edge 62, forming a corner therebetween. More specifically, the upper edges 50 of the inner and outer glass panes 34 and 36 of the front panel 32 are bonded to the lower surface 24 of the glass top 20.

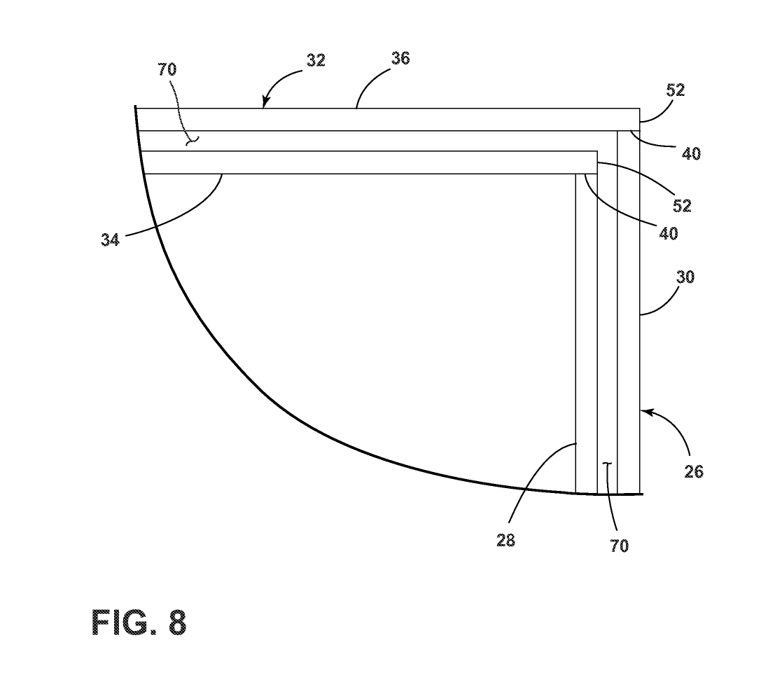

Referring to the detail view illustrated in FIG. 8, the front edge 40 of the side panel 26 is bonded to the front panel 32, along the side edge 52 of the front panel 32. More specifically, the inner glass pane 28 of the side panel 26 is bonded to the inner glass pane 34 of the front panel 32, and the outer glass pane 30 of the side panel 26 is bonded to the outer glass pane 36 of the front panel 32. The panels are bonded together, forming a corner therebetween.

Although the bonding material is not illustrated in the drawings, adjacent panels are bonded together using any suitable adhesive, glue, bonding agent, or other suitable material. In the current embodiments, the bonding material is ultraviolet adhesive, also known as ultraviolet light curing adhesive, in which ultraviolet light activates and cures the adhesive. Ultraviolet adhesives bond and seal materials, including glass, together. Further, ultraviolet adhesive hardens substantially transparently, has a relatively short curing time, and provides strong bond strength. Other suitable adhesives may be used. Transparent adhesives are preferred because of their reduced visibility. Other adhesives may be used, but may provide visual obstructions, although less visible than the frames of prior art cases.

As perhaps best seen in FIGS. 6 and 7, and as described above, the side and front panels 26 and 32 have spaced panes, defining a gap 70 therebetween. The gap 70 is maintained along the edges where adjacent panels meet by bonding the panels with a space therebetween; the bond is strong enough to maintain the spacing. However, the rear and lower edges 42 and 44 of the side panels 26 and the lower edge 54 of the front panels 32 are initially open or unbounded. A spacer 72 is located between the inner and outer panels along these edges 42, 44, and 54 to maintain the gap 70 therebetween. The panes are sealed to the spacer in conventional fashion to seal the edges together, enabling the interior to be sealed as is conventional for insulated glass. Accordingly, the side panels 26 and front panel 32 are insulated glass, while the glass top 20 is not insulated.

The insulated glass enclosure 10 is disposed atop the upper display area 16, and may be affixed and/or sealed to the cabinet 14 according to any known means. The glass enclosure 10 may be located in other areas in or on the display case 12, and indeed multiple glass enclosures could be provided. Further, as is conventional, the glass enclosure 10 may include doors 74, enclosing the rear of the insulated glass enclosure 10. The illustrated example does not include a bottom panel on the glass enclosure; however, a bottom panel is within the scope of the invention.

The construction of the present insulated glass enclosure 10 eliminates the spacer and metal frame, as is conventional, along the upper front and sides of the enclosure. This provides an unobstructed view of the upper display area 16 for a consumer standing in front of the display case 12.

### II. Second Embodiment

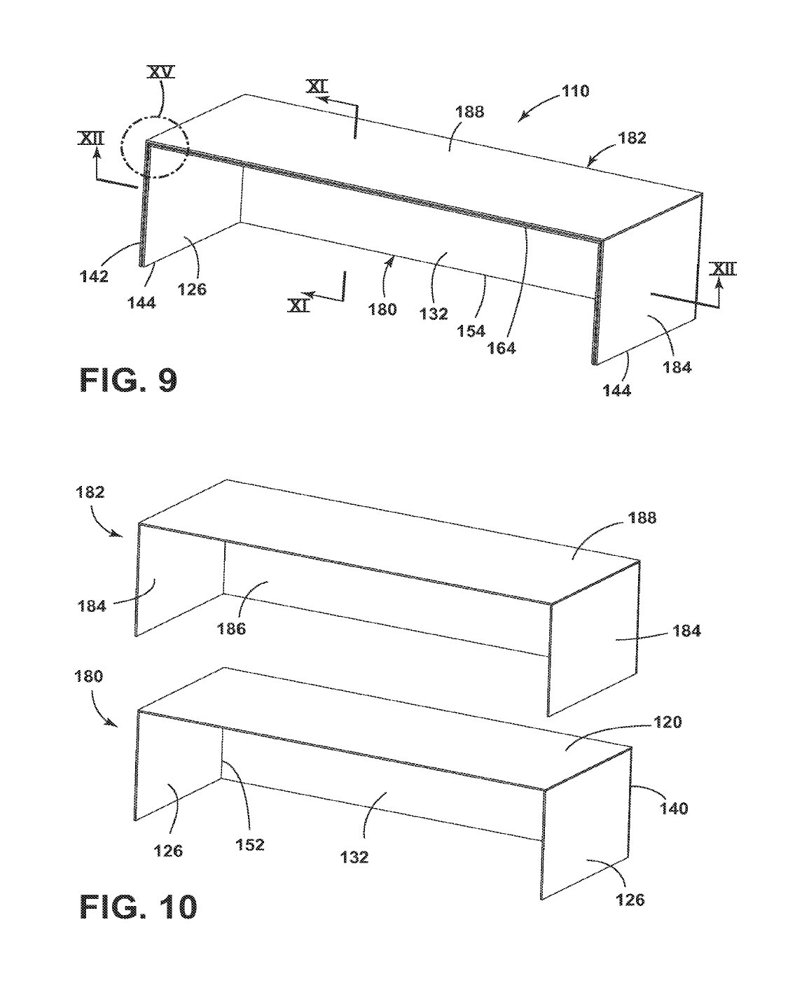

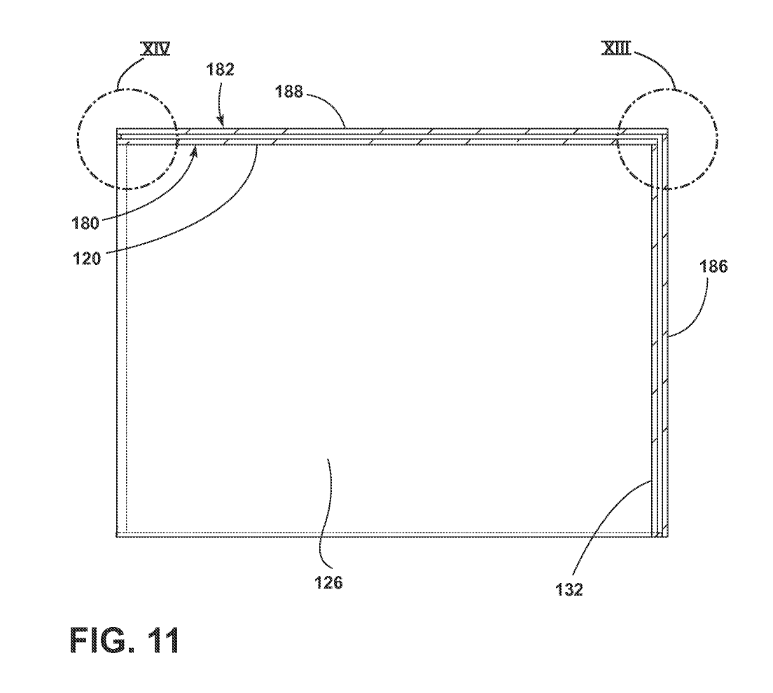

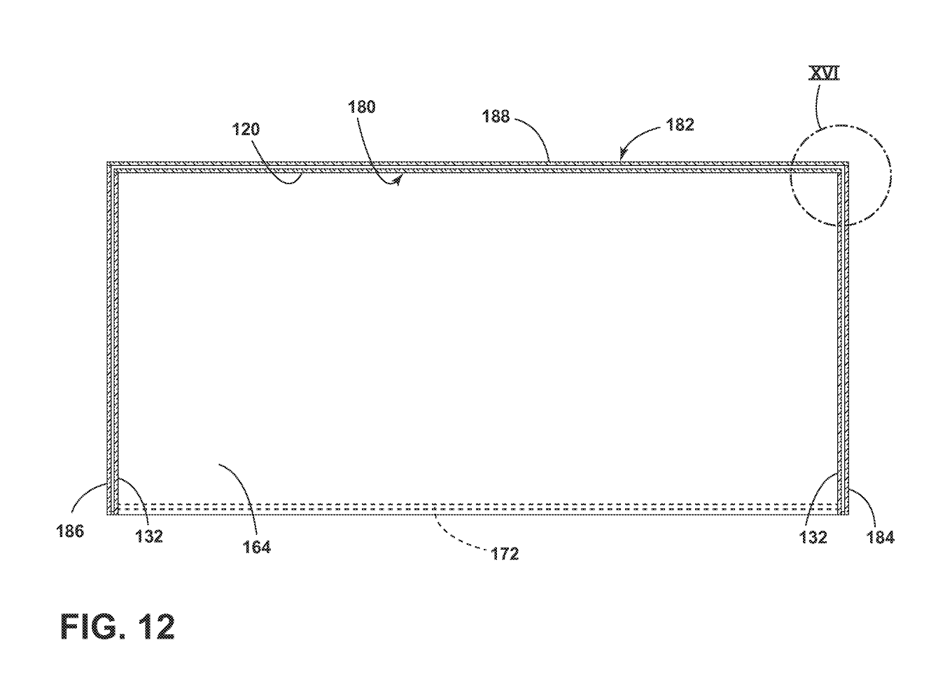

A second embodiment of the insulated glass enclosure 110 is illustrated in FIGS. 9-16. Like parts are identified with like numerals increased by 100. The insulated glass enclosure 110 of the second embodiment includes an inner enclosure 180 and an outer enclosure 182, both fabricated of single-pane glass. Referring to FIG. 10, the inner enclosure 180 includes two opposed side panels 126, a front panel 132, and a top panel 120. The outer enclosure 182 includes two opposed side panels 184, a front panel 186, and a top panel 188. Similar to the first embodiment, the panels are arranged to form a generally cubic structure having four sides where the adjacent sides are oriented at 90° angles, forming corners therebetween. Other numbers, shapes, and size of panels may be used depending on the desired configuration of the enclosure.

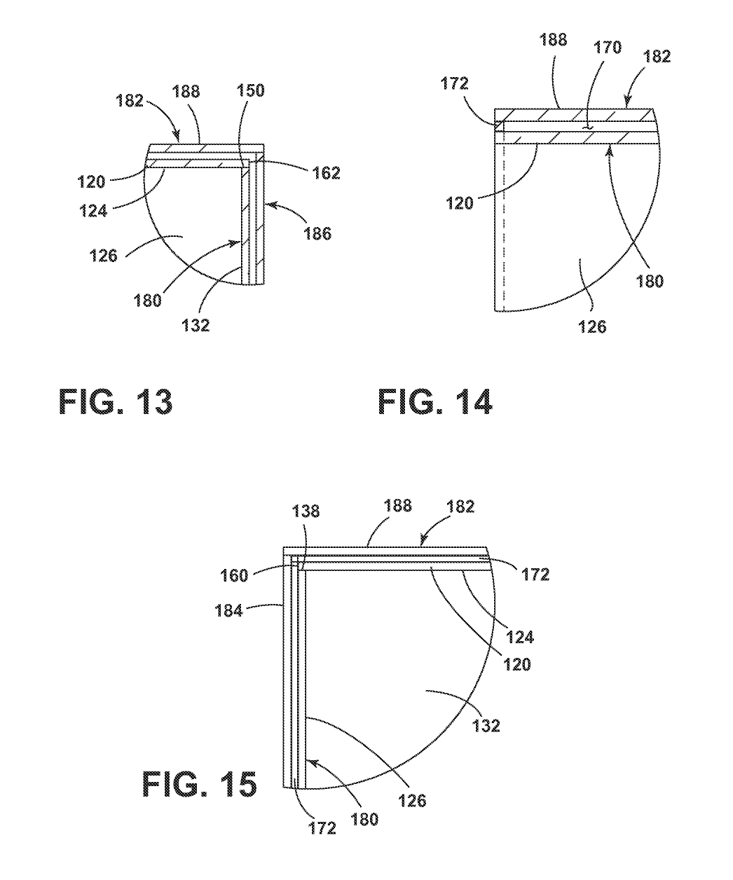

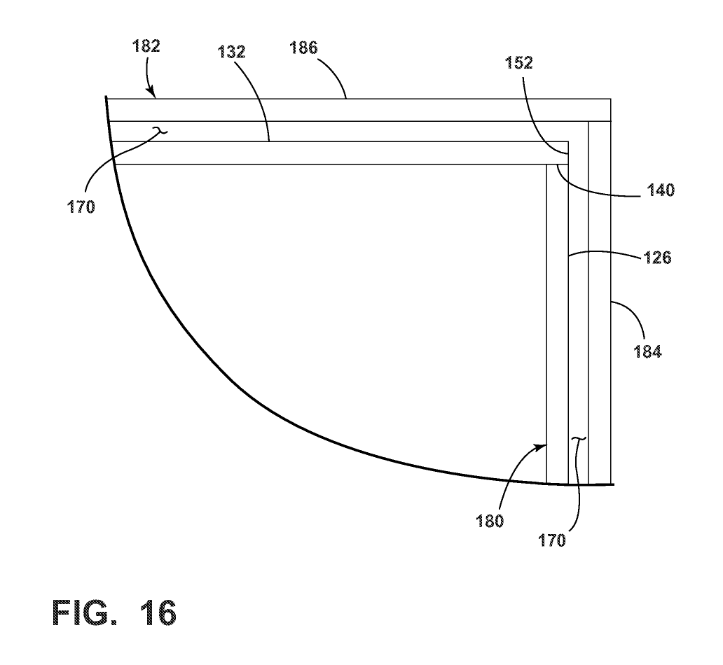

The inner enclosure 180 and the outer enclosure 182 are fabricated separately and then assembled together. Regarding the inner enclosure 180, the front edge 140 of the side panel 126 is bonded to the front panel 132, along the side edge 152 of the front panel 132, as shown in FIG. 16. The upper edge 138 of the side panel 126 is bonded to the lower surface 124 of the glass top 120, along the glass top's 120 side edge 160, as shown in FIG. 15. Referring now to FIG. 13, the upper edge 150 of the front panel 132 is bonded to the lower surface 124 of the glass top 120 along the glass top's 120 front edge 162. Adjacent panels are bonded together with ultraviolet adhesive, forming a corner therebetween. The opposed side panel is arranged in mirror image relationship to the described side panel 126 and does not require further description. Further, the outer enclosure 182 is constructed substantially the same as the inner enclosure 180 and does not require further description.

Accordingly, the inner enclosure 180 and the outer enclosure 182 are distinct and separate elements that together form the insulated glass enclosure 110. The inner enclosure 180 is dimensioned to fit within the outer enclosure 182 such that a gap 170 is defined therebetween when the inner enclosure 180 is positioned inside the outer enclosure 182. A spacer 172 is located between the inner and outer enclosures 180 and 182 along the rear and lower edges 142, 144, and 154 thereof. The spacer 172 maintains the gap 170 therebetween and seals the edges together, enabling the interior to be sealed as is conventional for insulated glass. Accordingly, all four surfaces of the glass enclosure 110 are insulated glass.

### III. Method of Manufacture of the Second Embodiment

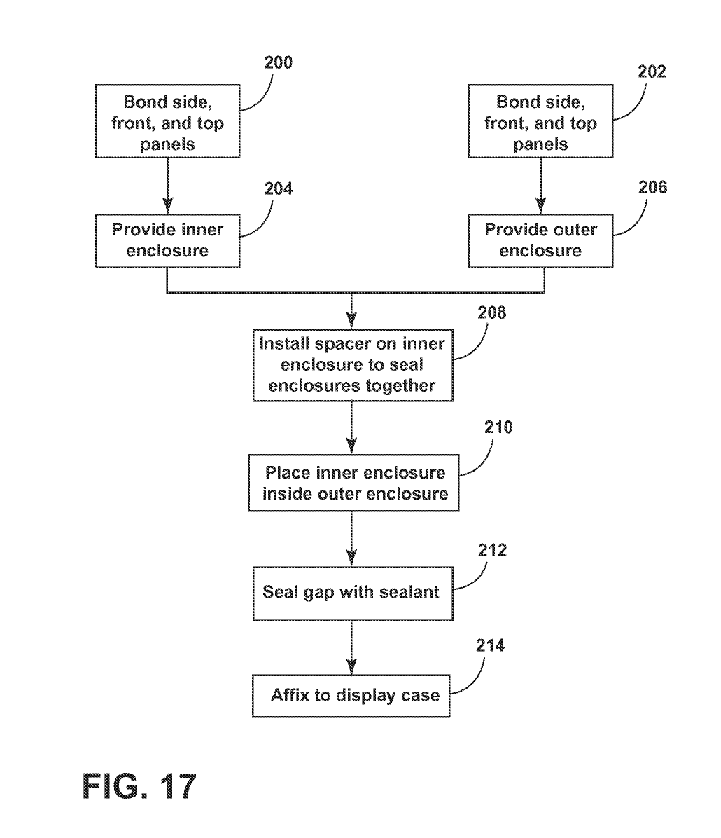

Referring now to the flow chart of FIG. 17, a method for forming the second embodiment of the insulated glass enclosure 110 includes first bonding the side, front, and top panels together as described above, at step 200 to manufacture the inner enclosure 180. Similarly, step 202 includes bonding the side, front, and top panels together to manufacture the outer enclosure 182. Steps 200 and 202 may be performed in any order or simultaneously. As described above, the bonding preferably is made using ultraviolet adhesive.

The method continues with providing the inner enclosure and outer enclosure at steps 204 and 206. At step 208, a spacer is applied on the outer surface of the inner enclosure and along the front, side, and rear edges. The inner enclosure is then placed inside the outer enclosure at step 210, and a gap is formed between the enclosures. Alternatively, a single spacer may be inserted continuously along the rear and lower edges of the enclosure. In either situation, the panels are adhered or otherwise sealed to the spacer in conventional fashion and sealant is used to fill any remaining gap between the spacer and the inner and outer enclosures at step 212. As part of the process, the space between the inner and outer enclosures 180, 182 is filled with an inert gas.

At step 214, the insulated glass enclosure 110 may be affixed to a display case 112.

The above descriptions are those of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A refrigerated display case comprising:
a cabinet;
a glass supported by the cabinet and comprising:
a glass top panel;
a front panel having spaced inner and outer glass panes, each of the inner and outer glass panes having an upper edge bonded to the top panel, each of the inner and outer glass panels further having two side edges; and
two side panels each having spaced inner and outer glass panes, each of the inner and outer glass panes having an upper edge bonded to the top panel, each of the inner and outer glass panels further having and a front edge bonded to the front panel.

2. The refrigerated display case of claim 1 wherein the inner glass pane of each side panel is bonded to the inner glass pane of the front panel.

3. The refrigerated display case of claim 2 wherein the front edge of the inner glass pane of each side panel is bonded to a side edge of the front panel, forming a corner therebetween.

4. The refrigerated display case of claim 2 wherein the outer glass pane of each side panel is bonded to the outer glass pane of the front panel.

5. The refrigerated display case of claim 4 wherein the front edge of the outer glass pane of each side panel is bonded to a side edge of the front panel, forming a corner therebetween.

6. The refrigerated display case of claim 1 wherein the side panels and the front panel have a lower edge and include a spacer between the inner and outer glass panes along the lower edge, the inner and outer glass panes bonded to the spacer.

7. The refrigerated display case of claim 1 wherein the side panels have a rear edge and a spacer disposed between the inner and outer glass panes along the rear edge, the inner and outer glass panes bonded to the spacer.

8. The refrigerated display case of claim 1 wherein the panes are bonded using ultraviolet adhesive.

9. A method of manufacturing an insulated glass enclosure for a refrigerated display case comprising:
providing an inner enclosure of inner glass panels bonded directly to one another;
providing an outer enclosure of outer glass panels bonded directly to one another;
placing the inner enclosure inside the outer enclosure with the inner panels spaced from the outer panels to define a gap between the inner and outer enclosures; and
sealing the inner and outer enclosures by inserting a spacer in the gap between the inner and outer enclosures and bonding the inner and outer enclosures to the spacer.

10. The method of claim 9 wherein the inner enclosure includes a front panel, a top panel, and two side panels.

11. The method of claim 10 wherein the outer enclosure includes a front panel, a top panel, and two side panels.

12. The method of claim 11 wherein the bonding step includes using ultraviolet adhesive.

13. The method of claim 12 wherein the sealing step includes sealing the gap with a sealant.
